(19) United States
(12) Patent Application Publication
(10) Pub. No.: US 2007/0226297 A1
(43) Pub. Date: Sep. 27, 2007

(54) Method and system to stop spam and validate incoming email

(76) Inventors: Richard A. Dayan, Wake Forest, NC (US); Jeffrey B. Jennings, Raleigh, NC (US)

Correspondence Address: DILLON & YUDELL LLP, 8911 N. CAPITAL OF TEXAS HWY.,, SUITE 2110, AUSTIN, TX, 78759, US

(21) Appl. No.: 11/385,546

(22) Filed: Mar. 21, 2006

(51) Int. Cl. G06F 15/16

(52) U.S. Cl. 709/206

(57) ABSTRACT

A match and destroy (MaDe) technique for filtering spam mail assigns at least two email addresses per user when the user first registers for an email account or when the MaDe software is installed on the server. The first email address is designated as the “True address,” and the user is made aware of only this address. The second email address is designated as the “Trap address,” and the user is not made aware of this address. Spammers send spam mail to all available email addresses as a spammer is unable to differentiate a True address from a Trap address. A MaDe filter is provided that detects when the same email is received in both the True and the Trap(s) inboxes. When this duplicate receipt occurs, the filter informs the resident spam filters that the email is a spam candidate.

### BACKGROUND OF THE INVENTION

1. Technical Field

The present invention relates generally to electronic computer communication and in particular to electronic mail communication. Still more particularly, the present invention relates to a method for reducing spam within electronic mail communication.

2. Description of the Related Art

Electronic mail (email) communication is utilized by a large and growing population of computer users. Each user has one or more email accounts having an inbox within which electronic mail that is addressed to the account is received. In recent years, businesses and persons desiring to spread their information to a large number of email users have resorted to a practice known as “spamming” within the computing environment. Spamming produces an un-solicited email from another user (often unknown to the recipient), and such email is referred to as spam or spam mail. Unfortunately, the practice of spamming has grown and it is not uncommon for a user to receive tens to hundreds of spam mail in his/her inbox over a 24-hour period.

Email spam is both a burden to the user receiving it and the servers processing it. Users who receive email have to determine what is valid (i.e., wanted) email and what is not. Sifting through and deleting of unwanted spam mail from the inbox gobbles up time and productivity. The same negative effects are experienced by the email servers that process and disseminate all email originating from and terminating at the various users assigned to the server.

One method of reducing the clutter in the user's inbox is the use of filtering. Several commercial filters have been created which attempt to sort the spam mail into a separate junk email box. However, the filtering process is usually an after-the-fact blocking technique. That is, a particular sender (email address) is identified as a spammer and any subsequent mail received from that sender (address), the filter recognizes the spammer and blocks the email from entering the user's inbox.

This filtering method works in theory, if the spammers keep the same email address or if the spammers keep the same subject title. However, experienced spammers are aware of this methodology and employ a variety of techniques to attempt to make their solicitations unique enough to bypass modern filters and blacklists. These techniques include counter-heuristical and other tricky spamming techniques such as source and destination forgery, randomized text body, and fake titles. With such methods being utilized to find ways around/through the filters, filtering spam is increasingly difficult because the spam mail typically does not have a single, easily recognizable signature to consistently filter upon.

### SUMMARY OF THE INVENTION

Disclosed is a method, system, and computer program product that substantially reduces or substantially eliminates the amount of spam mail received by a recipient email account. The technique provided is referred to as Match and Destroy (MaDe). MaDe acts as a filter assistant and ensures that the existing spam filters have a good and continually updated basis by which email can be filtered at the email server. The MaDe technique assigns at least two email addresses per user when the user first registers for an email account or when the MaDe software is installed on the server.

In one embodiment in which DHCP is utilized, two addresses are dynamically acquired. The first email address is designated as the “True address,” and the user is made aware of only this address. The second email address is designated as the “Trap address,” and the user is not made aware of this address. Because spammers typically collect as many email addresses as possible to have the broadest target for their message, both addresses are made available to the spammer, who assumes both to be valid addresses. The spammer is unable to differentiate the True addresses from the Trap addresses as that designation is guarded by the email server.

A MaDe filter is provided at the server, and once enabled, the MaDe filter detects when the same email is received in both the True and the Trap(s) inboxes. When this duplicate receipt occurs, the filter informs the resident spam filters that the email is a spam candidate. If the MaDe filter only sees an email in the Trap(s) inbox, the filter informs the spam filters that the email is spam, since there is no identifiable user of that address. If the MaDe filter only sees the email arriving for the True inbox, then the email is left alone to the existing filtering techniques.

In another embodiment, a server-side implementation is provided by creating several server Trap addresses. A fingerprint (hash) is generated for each incoming email. Then if any True address email fingerprint (hash) matches a Trap fingerprint, the email is tagged as spam. Further, any email that is sent to the Trap addresses is spam. Finally, email that is only sent to the True address is not stopped at the server and is passed on to the client email engine for further filtering.

In another embodiment, an enhancement to MaDe is provided to validate that email from a source is legitimate. This technique is referred to as Match and Certify (MaCe). MaCe works by expecting that all valid emails to be sent to a particular email address pair (or triplet or quadruplet, quintuplet, sextuplet, septuplet, and so on). The user's primary email address is the True address. The user's validating email address(es) is the Confirm address(es). If the user receives an email at his True email address and it was not accompanied by a duplicate email (by carbon copy (cc:) or to: or bcc:) to his Confirm email address then the email is not a legitimate one. Once both emails are received by a MaCe-enabled system, the MaCe filter tells the spam filters to let this email through now (and possibly in the future).

The above as well as additional objectives, features, and advantages of the present invention will become apparent in the following detailed written description.

### BRIEF DESCRIPTION OF THE DRAWINGS

The invention itself, as well as a preferred mode of use, further purposes, and advantages thereof, will best be understood by reference to the following detailed description of an illustrative embodiment when read in conjunction with the accompanying drawings, wherein:

FIG. 1 is a block diagram of a computer network within which email communication is enabled according to one embodiment of the invention;

FIG. 2 is a block diagram representation of a data processing system that may be utilized as either the server or client devices in the above computer network according to one embodiment of the invention;

FIGS. 3A-3B are flow charts of the two parts of the process involved in establishing a second email for utilization with spam filtering and subsequently detecting when an email is spam utilizing the match and destroy techniques, in accordance with one embodiment of the invention; and

FIG. 4 is a flow chart of the processes involved in detection when an email is spam utilizing the match and certify techniques according to one embodiment of the invention.

### DETAILED DESCRIPTION OF AN ILLUSTRATIVE EMBODIMENT

The present invention provides a method, system and computer program product that substantially reduces or substantially eliminates the amount of spam mail received by a recipient email account. The technique provided is referred to as Match and Destroy (MaDe). MaDe acts as a filter assistant and ensures that the existing spam filters have a good and continually updated basis by which email can be filtered at the email server.

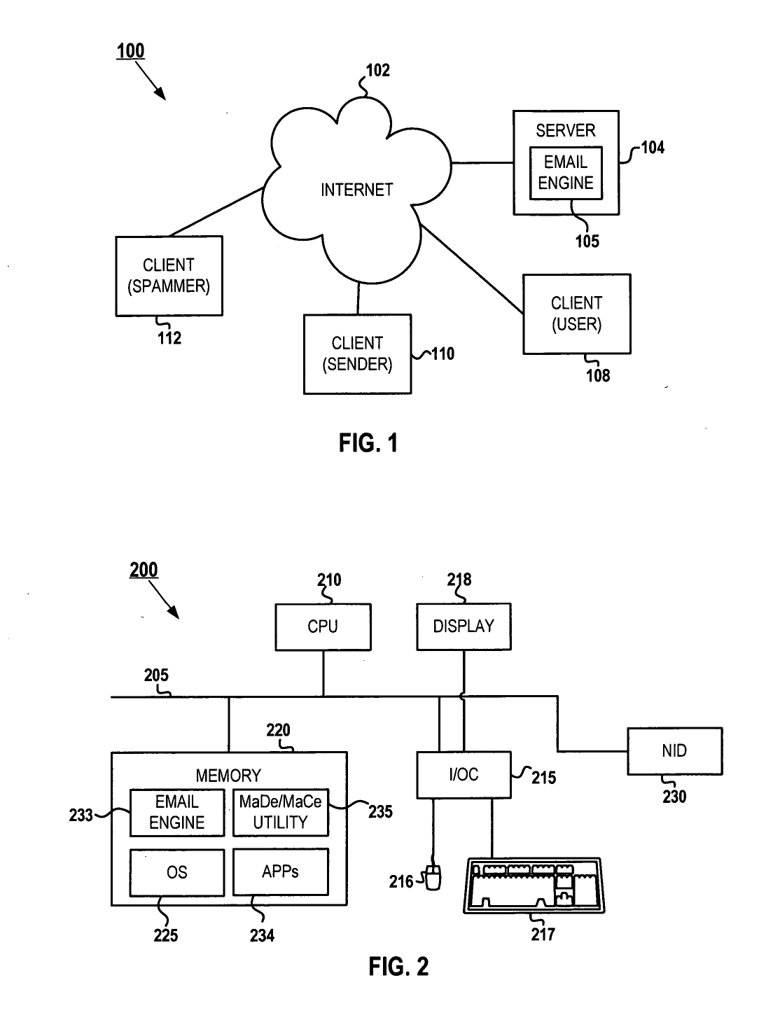

With reference now to the figures, FIG. 1 depicts a pictorial representation of a network of data processing systems (Network system 100) in which the present invention may be implemented. Network system 100 contains network connectivity 102 (also referred to as a network backbone/infrastructure), which is the medium utilized to provide communication links between various devices and computers connected together within network system 100. Network 102 may include connections, such as wire, wireless communication links, or fiber optic cables.

In the depicted example, network system 100 comprises email server 104 and multiple email clients 108, 110, and 112 connected to network 102, of which one client 108 is the recipient/receiving client (user), another client 110 is a sending client (sender) and a third client 112 is a spammer. For purposes of the invention, clients refer to the device and software by which an email communication may be created, transmitted and/or received. Also, the receiving client (108) may interchangeably be addressed according to its email inbox functionality.

Clients 108, 110, 112 may be, for example, personal computers or network computers. In the depicted example, email server 104 provides an email engine 105 that enables multiple clients 108, 110, 112 to register for an email account with a unique email address assigned thereto. In the described embodiment, email engine 105 also provides spam pre-filtering functions via either one or a combination of MaDe or MaCe techniques, which are described in details below. Network system 100 may include additional servers, clients, and other devices not shown.

In the described embodiment, network system 100 is the Internet with network connectivity 102 representing a worldwide collection of networks and gateways that utilize the Transmission Control Protocol/Internet Protocol (TCP/IP) suite of protocols to communicate with one another. Of course, network system 100 also may be implemented as a number of different types of networks, such as an intranet, a local area network (LAN), or a wide area network (WAN), for example. FIG. 1 is intended as an example, and does not imply any architectural limitations on the present invention.

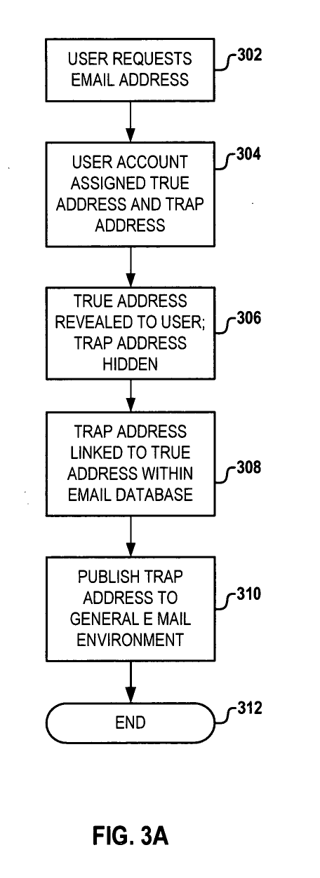

Referring now to FIG. 2, there is depicted a block diagram representation of a data processing (or computer) system that may be implemented as a server, such as email server 104 in FIG. 1 (or as one of clients 108, 110, 112), in accordance with the illustrative embodiment of the present invention. Computer system 200 comprises processor 210 coupled to memory 220, and input/output (I/O) controller 215 via a system bus 205. I/O controller 215 provides the connectivity to and/or control over input/output devices, including mouse 216, keyboard 217 and display device 218.

Computer system 200 also comprises a network interface device (NID) 230 utilized to connect computer system 200 to another computer system and/or computer network (as illustrated by FIG. 1). NID 230 provides interconnectivity to an external network through a gateway or router, or similar device. NID 230 may be an Ethernet card or modem, for example, depending on the type of network (e.g., local area network (LAN) or wide are network (WAN)) to which the computer system 200 is connected.

In one embodiment, the hardware components of computer system 200 are of conventional design. Computer system 200 may also include other components (not shown) such as fixed disk drives, removable disk drives, CD and/or DVD drives, audio components, modems, network interface components, and the like. It will therefore be appreciated that the system described herein is illustrative and that variations and modifications are possible. Further, the techniques for messaging middleware functionality may also be implemented in a variety of differently-configured computer systems. Thus, while the invention is describe as being implemented in a computer system 200, those skilled in the art appreciate that various different configurations of computer systems exists and that the features of the invention are applicable regardless of the actual configuration of the computer system.

Located within memory 220 and executed on processor 210 are a number of software components, including operating system (OS) 225 (e.g., Microsoft Windows®, a trademark of Microsoft Corp, or GNU®/Linux®, registered trademarks of the Free Software Foundation and The Linux Mark Institute) and a plurality of software applications, including email engine 233 and MaDe utility 235. Among the software components are components for providing general email server functionality, components for enabling network connection and communication via NID 230 (e.g., a modem or network adapter), and more specific to the invention, code for enabling the “spam pre-filtering” functionality of the invention. For simplicity, the collective body of code that enables the duplicate assigning of email addresses and subsequent spam pre-filtering features are referred to hereinafter as the MaDe utility 235 (or MaCe utility for the alternate embodiment described below). In actual implementation, the MaDe utility may be added to existing email engine code to provide the enhanced email assignment and filtering.

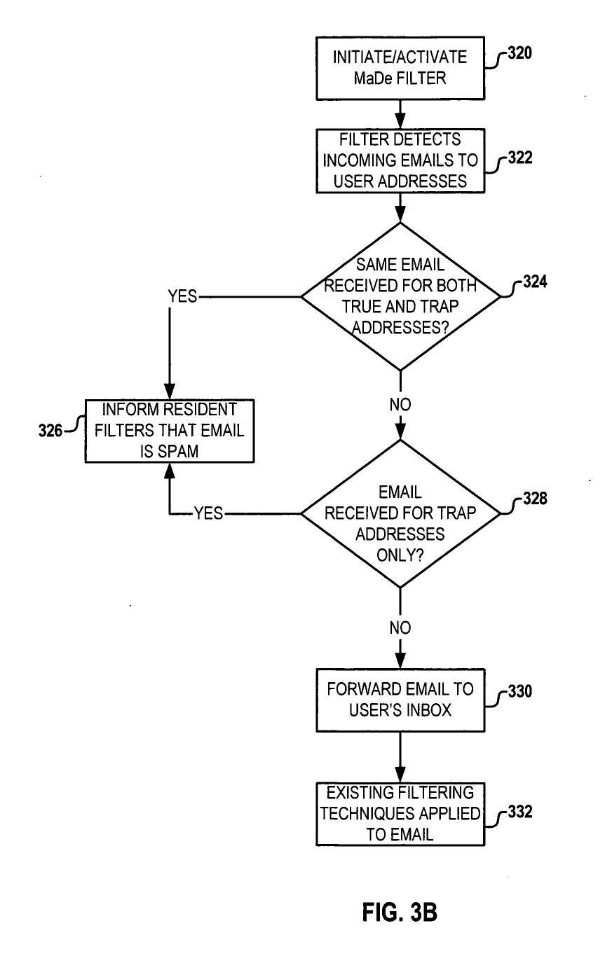

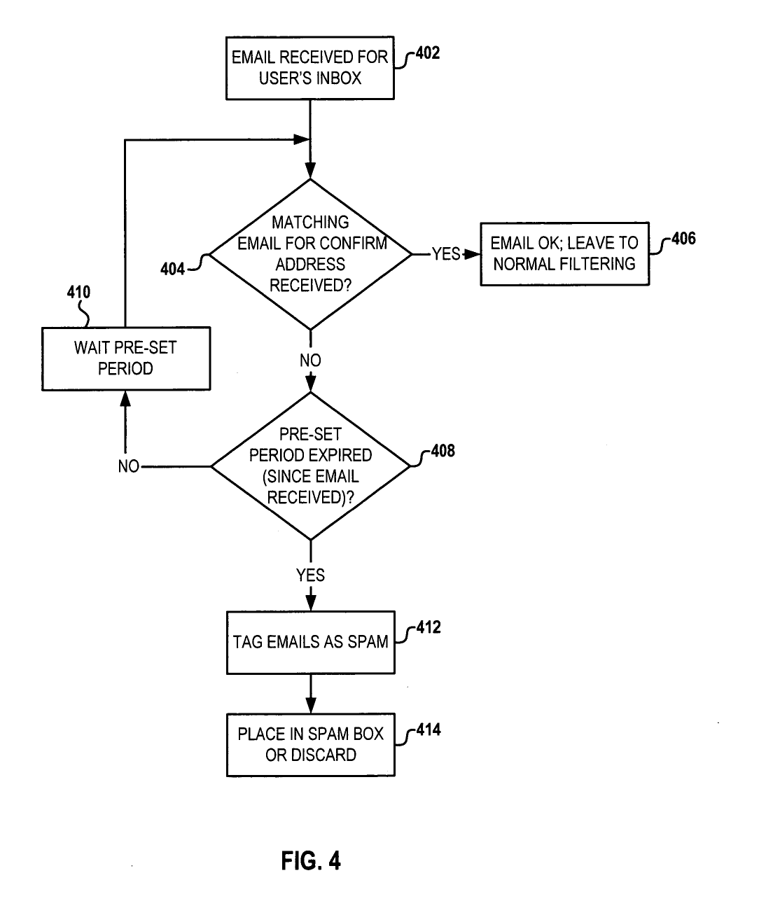

Processor 210 executes these (and other) application programs 234 (e.g., network connectivity programs) as well as OS 225, which supports the application programs. According to the illustrative embodiment, processor 210 executes OS 225, applications 234 (namely network access applications/utilities), and MaDe utility 235 to provide/enable the spam pre-filtering features and functionality described herein and illustrated by FIGS. 3 and 4.

FIG. 3 is a flow chart, which illustrates the process steps completed by the MaDe utility 235, according to one embodiment. As shown by block 302, the process begins when a user requests is received by email engine for a new email address or a “Trap” address. According to the invention, when a request for new email address is received, the MaDe utility automatically assigns at least two email addresses to the user, as shown at block 304.

Notably, in one embodiment, the assignment of the second or multiple email address occurs both when the user first registers for an email and/or when the MaDe utility is installed on the email server. In one embodiment utilizing DHCP (Dynamic Host Configuration Protocol), two addresses are dynamically acquired. According to the described embodiment, one email address is designated as the “True address,” and the user is made aware of only this address, as indicated at block 306. The next email address is designated as the “Trap address,” and this email address is not provided to the user (i.e., the user has no actual knowledge of this address). The email engine links the Trap address with the True address within the server's email database, as indicated at block 308.

Then, as provided at block 310, both addresses are made available to the general email environment, which includes spammers. Because spammers typically collect as many email addresses as possible to have the broadest target for their message, these spammers assume both addresses to be valid addresses which represents two separate email accounts. The spammer is unable to differentiate the True addresses from the Trap addresses as that designation is guarded by the email server.

The MaDe technique may be implemented as either a client-side system or a server-side system. For simplicity, the invention is described as a server-side system with each email user assigned at least two (2) email addresses, one True address and one Trap address. These Trap email addresses are then published (e.g., posted to a newsgroup) so that potential spammers will attempt to contact the newly acquired targets as they attempt to collect as many email as possible to increase the targets for their message.

FIG. 3B illustrates the process by which the email engine utilizes the combination of Trap and True addresses to determine which received emails to screen out. Typically, in implementation, the user decides which sources are legitimate ones to receive email from and provides the source(s) with his/her True email address. Because the user is unaware of the Trap address(es), the Trap address is never given out to legitimate sources. A legitimate source would thus send email to only the True address, while a spammer sends spam mail to all addresses on his list, including the Trap address(es). The invention recognizes that, typically, an over zealous spammer does not take time to individually enter known addresses, but sources the addresses from a newsgroup or some other grouping of addresses.

Returning to FIG. 3B, a MaDe filter is provided and initiated at the server, as shown at block 320. Once enabled, the MaDe filter detects incoming emails at block 322 and the filter checks at block 324 whether the same email is received in both the True and the Trap inboxes. When this duplicate receipt occurs, the filter informs the resident spam filters of the email server that the email is a spam candidate, as shown at block 326. If, however, the MaDe filter does not detect duplication, a next determination is made at block 328 whether the filter detects receipt of an email in only the Trap(s) inbox. If an email is received in only a Trap email inbox, the filter informs the spam filters (at block 326) that the email is spam, since there is no identifiable user of that Trap address. Otherwise, if the MaDe filter only sees the email arriving for the True inbox, then the email is passed on to the users email inbox, as indicated at block 330, and the email is left alone to the existing filtering techniques as shown at block 332.

In the client-side implementation, the MaDe filter detects when the same email is received in both the True and the Trap(s) inbox, and the MaDe filter informs the resident spam filters that the email is a spam candidate. If MaDe only sees an email in the Trap(s), the MaDe filter informs the resident filters that the email is spam. If the MaDe filter only sees the email in the True inbox then the email is left alone to the existing filtering techniques. Also, with a client-side implementation, the Trap address(es) is not made public to legitimate sources by the user so the user who is not aware of the second email account does not check the account for email. In one embodiment, the MaDe utility creates multiple Trap addresses and peppers these Trap addresses throughout the Internet to entice the often over-zealous spammer.

In one embodiment, multiple Trap addresses are assigned per single user to further improve coverage as spammers become more sophisticated or attempt to exclude/include specific addresses, perhaps based on a lack of response or other methods. In yet another embodiment, a server-side implementation is provided by creating several server Trap addresses. A fingerprint (hash) is generated for each incoming email. Then, if any True address email fingerprint (hash) matches a Trap fingerprint, the email is tagged as spam. Further, any email that is sent to the Trap addresses is spam. Finally, email that is only sent to the True address is not stopped at the server and is passed on to the client email engine for further filtering.

In one embodiment in which multiple Trap addresses (or Confirm addresses) are utilized, a revolving True-Trap or True-Confirm address pair may be implemented by which the Trap or Confirm address changes periodically to another one within the list of available Trap or Confirm addresses, respectively. Further, the True address may itself be interchangeable in one embodiment. With this embodiment, the client software, e.g., Lotus Notes®, lets the user type in the name of the recipient. The client/server software resolves the recipient name into an email address and transmits the email content. Coordination between trusted secure source and destination email servers ensures that the True and Confirm address are known. A shared temporal algorithm may be exchanged or the servers may communicate in real-time via their own SMTP messages.

In another alternate embodiment, an enhancement to MaDe is provided to validate that email from a source is legitimate. This technique is referred to as Match and Certify (MaCe) and involves executing a MaCe utility at the user device or at an email server. MaCe works by expecting that all valid emails are to be sent to a particular email address pair (or triplet or quadruplet, quintuplet, sextuplet, septuplet, and so on). The user's primary email address is the True address. The users validating email address(es) are referred to as the Confirm address(es).

The client and or server software are enhanced to make sure that the software of the recipient and legitimate sending addresses are made aware of the Confirm address as well as the True address. Once the Confirm address is known, the client or server software is able to send the duplicate validating email to the Confirm address Once both emails are received by a MaCe-enabled system, the MaCe filter tells the spam filters to let this email through now (and possibly in the future).

FIG. 4 illustrates how the process by which the MaCe technique is implemented. As shown at block 402, the process begins with the receipt of an email addressed to one of the user's email addresses. A check is made at block 404 whether a matching email for the confirm email address has been received. If only one of the paired addresses receives the email (only one email address has received an email), a determination is made at block 408 if a pre-set period of time has elapsed without receiving the matching email at the other address. If the pre-set period has not expired, the email is held for the pre-set period of time as shown at block 410, and then the check for the matching email is repeated. If, at decision block 404, the matching email is received for the confirm address, then the email is considered okay (i.e., not from a spammer), and the email is passed to the user's inbox to undergo the normal filtering, as provided at block 406. When the period of time expires (at block 408) without receipt of the matching email, the email in the first email address inbox is tagged as spam mail, as shown at block 412. Then, the email is placed in the spam folder or discarded, as indicated at block 414.

According to the above described process. If the user receives an email at his True email address and it was not accompanied by a duplicate email (by carbon copy (cc:) or to: or bcc:) to his Confirm email address then the MaCe utility recognizes that the email is not a legitimate one (i.e., is most probably not from a legitimate sender). As with MaDe's multiple Trap addresses, one embodiment provides implementation of MaCe techniques with multiple confirming addresses.

According to the invention, the naming schemes for the Trap and the Confirm addresses are arbitrary. That is, these addresses may play off the True address or be randomly assigned/named. Additionally, the True, Trap, and Confirm addresses do not necessarily have the same email domain. In one embodiment, email domains are server coordinated to validate the emails.

In one embodiment, the True, Trap, and Confirm addresses are revolved through a predefined list. With this embodiment, a single user may be assigned five addresses and then for a MaDe system, one address is the True address, while the remaining addresses are the Trap addresses for one day. The following day, however, another one of the addresses is assigned as the True address, with the remaining addresses again utilized as the Trap addresses. This revolving assignment of the True address may also be extended to a MaCe system, with True and Confirm addresses. Based on this implementation, the user sending an email does not need to know what the True address is for a given day (or period). Rather, the client software, e.g., Lotus Notes®, lets the user type in the name of the recipient. The client/server software resolves this email into an email address and transmits to the recipient. Coordination between trusted secure source and destination email servers would then ensure that the True and Confirm address are known. This is achieved by en exchange of a shared temporal algorithm or communication among the servers in real-time via their own SMTP messages.

In one embodiment, a company may sell services to their customers, which ensures that their customers assigned Trap addresses are as dispersed as possible throughout the Internet. This would ensure that spammers have certain email addresses on their spam lists. This service would then ensure the functionality of the MaDe and MaCe systems.

As a final matter, it is important that while an illustrative embodiment of the present invention has been, and will continue to be, described in the context of a fully functional computer system with installed management software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. In an email environment, a method comprising:
assigning at least two email addresses to a user, the addresses comprising at least a True address and a second address;
publishing at least one of the email addresses, the published email address being an address that is utilized to determine when an email addressed to the user is a valid email from a legitimate sender; and
when an email is received by the user addressed to the True address, automatically checking the second address for receipt of a matching email to determine whether the email received at the True address is a valid email;
when the email is determined to not be a valid email based on the result of the automatically checking step, dynamically tagging the email as spam mail and passing the email to a spam filter for handling as spam mail.

2. The method of claim 1, wherein:
the assigning further comprises assigning the second address as a Trap address, wherein the Trap address is not made known to the user; and
the automatically checking comprises checking the Trap address for receipt of a matching email at the Trap address; and
the dynamically tagging comprises tagging the email as spam mail only when a matching email is received at the Trap address, wherein when no matching email is received, the received email at the True address is not tagged as spam mail.

3. The method of claim 2, further comprising:
determining when an email is received at only the Trap address; and
when the email is received at only the Trap address, initiating the dynamically tagging step for the email received at the Trap address and discarding the email received at the Trap address.

4. The method of claim 1, further comprising:
assigning multiple ones of the second address to the user; and
performing the automatically checking with each of the multiple ones of the second address, wherein the dynamically tagging is triggered whenever any one of the multiple ones of the second address includes the matching email.

5. The method of claim 1, wherein
the assigning further comprises assigning the second address as a Confirm address, wherein the Confirm address is not made known to the user; and
the automatically checking comprises checking the Confirm address for receipt of a matching email at the Confirm address; and
the dynamically tagging comprises tagging the email as spam mail only when a matching email is not received at the Confirm address, wherein when a matching email is received, the received email at the True address is not tagged as spam mail.

6. The method of claim 5, further comprising:
determining when an email is received at only the Confirm address; and
when the email is received at only the Confirm address, passing the email to a spam filter at the user email engine for further filtering.

7. The method of claim 1, further comprising:
assigning multiple ones of the second address to the user; and
performing the automatically checking with each of the multiple ones of the second address, wherein the dynamically tagging is triggered whenever one of the multiple ones of the second address includes the matching email.

8. The method of claim 1, wherein the steps are performed at an email server within the email environment, wherein the server maintains a record of the True address and the second address, which is linked to the True address for analyzing potential spam mail.

9. A computer program product comprising:
a computer readable medium; and
program code for execution on a device within an email environment, said code comprising code that when executed on a processor performs the steps of:
assigning at least two email addresses to a user, said addresses comprising at least a True address and a second address;
publishing at least one of said email addresses, said published email address being an address that is utilized to determine when an email addressed to the user is a valid email from a legitimate sender;
when an email is received by said user addressed to the True address, automatically checking the second address for receipt of a matching email to determine whether the email received at the True address is a valid email; and
when the email is determined to not be a valid email based on the result of the automatically checking step, dynamically tagging said email as spam mail and passing said email to a spam filter for handling as spam mail.

10. The computer program product of claim 9, wherein:
said code for assigning further comprises code for assigning said second address as a Trap address, wherein said Trap address is not made known to the user; and
said automatically checking code comprises code for checking said Trap address for receipt of a matching email at said Trap address; and
said dynamically tagging code comprises code for tagging said email as spam mail only when a matching email is received at the Trap address, wherein when no matching email is received, the received email at the True address is not tagged as spam mail.

11. The computer program product of claim 10, further comprising code for:
determining when an email is received at only the Trap address; and
when the email is received at only the Trap address, initiating said dynamically tagging step for the email received at the Trap address and discarding the email received at the Trap address.

12. The computer program product of claim 9, further comprising code for:
assigning multiple ones of said second address to said user; and
performing said automatically checking with each of said multiple ones of said second address, wherein said dynamically tagging is triggered whenever any one of the multiple ones of the second address includes the matching email.

13. The computer program product of claim 9, wherein
said assigning code further comprises code for assigning said second address as a Confirm address, wherein said Confirm address is not made known to the user; and
said automatically checking code comprises code for checking said Confirm address for receipt of a matching email at said Confirm address; and
said dynamically tagging code comprises code for tagging said email as spam mail only when a matching email is not received at the Confirm address, wherein when a matching email is received, the received email at the True address is not tagged as spam mail.

14. The computer program product of claim 13, further comprising code for:
determining when an email is received at only the Confirm address; and
when the email is received at only the Confirm address, passing the email to a spam filter at the user email engine for further filtering.

15. The computer program product of claim 9, further comprising code for:
assigning multiple ones of said second address to said user; and
performing said automatically checking with each of said multiple ones of said second address, wherein said dynamically tagging is triggered whenever one of the multiple ones of the second address includes the matching email.

16. The computer program product of claim 9, wherein the processes provided by the various code are performed at an email server within the email environment, wherein said server maintains a record of the True address and the second address, which is linked to the True address for analyzing potential spam mail.

17. A system comprising:
a processor and memory;
a network connectivity device for coupling the system to an external email communication network; and
program code for executing on the processor and which performs the steps of:
assigning at least two email addresses to a user, said addresses comprising at least a True address and a second address;
publishing at least one of said email addresses, said published email address being an address that is utilized to determine when an email addressed to the user is a valid email from a legitimate sender;
when an email is received by said user addressed to the True address, automatically checking the second address for receipt of a matching email to determine whether the email received at the True address is a valid email; and
when the email is determined to not be a valid email based on the result of the automatically checking step, dynamically tagging said email as spam mail and passing said email to a spam filter for handling as spam mail.

18. The system of claim 17, wherein:
said code for assigning further comprises code for assigning said second address as a Trap address, wherein said Trap address is not made known to the user; and
said automatically checking comprises code for checking said Trap address for receipt of a matching email at said Trap address; and
said dynamically tagging comprises code for tagging said email as spam mail only when a matching email is received at the Trap address, wherein when no matching email is received, the received email at the True address is not tagged as spam mail.
said system further comprising code for:
determining when an email is received at only the Trap address;
when the email is received at only the Trap address, initiating said dynamically tagging step for the email received at the Trap address and discarding the email received at the Trap address;
assigning multiple ones of said second address to said user; and
performing said automatically checking with each of said multiple ones of said second address, wherein said dynamically tagging is triggered whenever any one of the multiple ones of the second address includes the matching email.

19. The system of claim 17, wherein:
said assigning code further comprises code for assigning said second address as a Confirm address, wherein said Confirm address is not made known to the user; and
said automatically checking code comprises code for checking said Confirm address for receipt of a matching email at said Confirm address; and
said dynamically tagging code comprises code for tagging said email as spam mail only when a matching email is not received at the Confirm address, wherein when a matching email is received, the received email at the True address is not tagged as spam mail; and
said system further comprising code for:
determining when an email is received at only the Confirm address;
when the email is received at only the Confirm address, passing the email to a spam filter at the user email engine for further filtering;
assigning multiple ones of said second address to said user; and
performing said automatically checking with each of said multiple ones of said second address, wherein said dynamically tagging is triggered whenever none of the multiple ones of the second address includes the matching email.

20. The system of claim 17, wherein said system is an email server, wherein said server maintains a record of the True address and the second address, which is linked to the True address for analyzing potential spam mail.
